(19) United States
(12) Patent Application Publication
(10) Pub. No.: US 2012/0178863 A1
(43) Pub. Date: Jul. 12, 2012

(54) INKJET COMPOSITION FOR FORMING A TRANSPARENT FILM, AND TRANSPARENT FILM FORMED FROM SAME

(76) Inventors: Mun-Ho Kim, Yuseong-gu (KR); Seung-Hee Lee, Seodaemun-gu (KR); Han-Soo Kim, Yuseong-gu (KR); Min-A Yu, Yuseong-gu (KR); Dae-Hyun Kim, Yuseong-gu (KR)

(21) Appl. No.: 13/395,844

(22) PCT Filed: Sep. 10, 2010
(86) PCT No.: PCT/KR2010/006188

§ 371 Date: Mar. 13, 2012

(30) Foreign Application Priority Data
Sep. 15, 2009 (KR) 10-2009-0087097
Sep. 10, 2010 (KR) 10-2010-0088723

(51) Int. Cl. C08K 5/103; C08K 5/101; C09D 133/08

(52) U.S. Cl. 524/317; 524/560

(57) ABSTRACT

An inkjet composition for a transparent film includes a) a binder polymer, b) a polymerizable monomer, c) a polymerization initiator, and d) a solvent having a boiling point of 150° C. or more. Using the inkjet composition according to the embodiments of the present invention, the transparent film may be directly manufactured at a desired position by using the inkjet process, while using a small amount of ink, thereby increasing the efficiency of the manufacturing process. Also, due to the excellent jetting properties thereof, it is advantageous to forming the transparent film. Furthermore, the excellent transmittance and heat resistance may be obtained.

### TECHNICAL FIELD

The present invention relates to an inkjet composition for a transparent film, which can be used in an inkjet process and has excellent permeability and thermal stability.

### BACKGROUND ART

An inkjet process has been widely used to manufacture color filters or interconnections of liquid crystal displays, organic EL displays, plasma displays, and so on. The inkjet process is a process to form a desired thin film by printing a liquid source material onto previously designed patterns using an inkjet apparatus and drying the printed liquid source material. Hence, it has been known that the inkjet process is a very innovative process, both in economic and environmentally-friendly terms because a smaller amount of materials are used, as compared to an existing process. A transparent coating composition has been generally used as an overcoat material in a liquid crystal display process. An overcoat covers an underlying layer to make the height of the underlying layer uniform and protect the underlying layer from heat or chemicals. In the manufacturing of the liquid crystal display, an overcoat transparent coating solution is coated on the underlying layer at a uniform thickness by using a spin coater or a slit coater. In particular, a case in which a transparent film such as an overcoat must be formed in a region larger than a predetermined area requires greater excellence in jetting stability as compared to a case of forming patterns.

In this regard, the composition of a transparent coating solution is very important. Also, the application range of the transparent coating solution has recently been gradually expanded. As one example, the transparent coating solution is used as a write ink in an RGBW-plus system which has improved brightness by adding a write (W) layer to an existing three-color filter system having red (R), green (G) and blue (B) layers.

### DISCLOSURE

### Technical Problem

An aspect of the present invention provides an inkjet composition for a transparent film, which has excellent permeability and thermal stability, and more particularly, an inkjet composition for a transparent film, which can be used as an overcoat material of an electronic device because of its excellent jetting properties and can be used as a white (W) pattern of a color filter.

### Technical Solution

According to an aspect of the present invention, there is provided an inkjet composition for a transparent film, including: a binder polymer; a polymerizable monomer; a polymerization initiator; and a solvent having a boiling point of 150° C. or more.

According to another aspect of the present invention, there is provided a transparent film manufactured by the inkjet composition.

According to another aspect of the present invention, there is provided a method for manufacturing a transparent film, including forming a transparent film using the inkjet composition through an inkjet process.

According to another aspect of the present invention, there is provided an electronic device including the transparent film as an overcoat.

According to another aspect of the present invention, there is provided a color filter including the transparent film as a white pattern.

### Advantageous Effects

Using the inkjet composition according to the embodiments of the present invention, the transparent film may be directly manufactured at a desired position by using the inkjet process, while using a small amount of ink, thereby increasing the efficiency of the manufacturing process. Also, due to the excellent jetting properties thereof, it is advantageous to forming the transparent film. Furthermore, the excellent transmittance and heat resistance may be obtained.

### BEST MODE

An embodiment of the present invention provides an inkjet composition including a) a binder polymer, b) a polymerizable monomer, c) a polymerization initiator, and d) a solvent having a boiling point of 150° C. or more. The inkjet composition has a three-dimensional mesh structure. The three-dimensional mesh structure makes an ink film strong, thereby improving chemical resistance or abrasion resistance of the ink film.

a) The binder polymer is not specifically limited, and typical materials known in the art to which the invention pertains may be selectively used without specific limitations. For example, the binder polymer may be prepared by polymerizing acrylate monomer, acrylate oligomer, or a mixture thereof. At this time, the acrylate monomer or the acrylate oligomer may have at least one acrylate functional group which can participate in a curing reaction. In order to participate in the curing reaction, the acrylate function group may be located at a side chain of the binder polymer. During the curing reaction, the binder polymer is reacted and crosslinked with the polymerized monomer to form the three-dimensional mesh structure. The acrylate monomer and the acrylate oligomer are not specifically limited, and typical materials known in the art to which the invention pertains may be selectively used without specific limitations.

The acrylate monomer may be selected from the group consisting of dipentaaerythritol hexaacrylate, dipentaaerythritol hydroxyl pentaacrylate, pentaerythritol tetraacrylate, pentaerythritol triacrylate, trimethylene propyl triacrylate, propoxylated glycerol triacrylate, trimethylopropane ethoxy triacrylate, 1,6-hexanedioldiacrylate, propoxylated glycero triacrylate, tripropylene glycol diacrylate, ethylene glycol diacrylate, and a mixture thereof; however, the acrylate monomer is not limited thereto.

The acrylate oligomer may be selected from the group consisting of urethane acrylate oligomer, epoxy acrylate oligomer, polyester acrylate, polyether acrylate, and a mixture thereof; however, the acrylate oligomer is not limited thereto.

The content of the binder polymer may range from 1 wt % to 40 wt % with respect to a total weight of the inkjet composition for the transparent film.

When the content of the binder polymer is less than 1 wt %, the strength of a manufactured transparent film may be lowered. When the content of the binder polymer is more than 40 wt %, the viscosity of the inkjet composition may increase to greatly degrade the jetting properties thereof.

The weight average molecular weight of the binder polymer may range from 1,000 to 100,000. When the weight average molecular weight of the binder polymer is less than 1,000, the heat resistance and film strength of the manufactured transparent film may be lowered. When the weight average molecular weight of the binder polymer is more than 100,000, the solubility of the binder in the solvent is not high and the viscosity of the entire ink, including the binder, is increased. Thus, the jetting properties of the entire ink may be degraded and the surface uniformity of the manufactured transparent film may be degraded.

b) The polymerizable monomer is a multifunctional monomer having an ethylenically unsaturated double bond. The polymerizable monomer may have two or more functional groups within a molecule. The polymerizable monomer causes a polymerization reaction by a radical active species formed from a polymerization initiator to form a three-dimensional mesh structure. Specifically, a monomer having two or more ethylenically unsaturated double bonds are polymerized, and the polymerized monomer is reacted and crosslinked with the binder polymer having an acrylate functional group at a side chain. As a result of the crosslinking, a three-dimensional mesh structure is formed.

The polymerizable monomer may be one or more material selected from the group consisting of: a compound prepared by esterify polyhydric alcohol into a, p-unsaturated carboxyl acid, the polyhydric alcohol including ethylene glycol di(metha)acrylate, polyethylene glycol di(metha)acrylate having 2-14 ethylene groups, trimethylolpropane di(metha)acrylate, trimethylolpropane tri(metha)acrylate, pentaerythritol tri(metha)acrylate, pentaerythritol tetra(metha)acrylate, 2-trisacryloyloxymethylethyl phthalic acid, propylene glycol di(metha)acrylate having 2-14 propylene groups, dipentaaerythritol penta(metha)acrylate, or dipentaaerythritol hexa(metha)acrylate; a compound prepared by adding (metha)acrylic acid to a compound containing a glycidyl group, such as trimethylolpropane triglycidyl ether acrylic acid adduct, and bisphenol A diglycidyl ether acrylic acid adduct; an ester compound of polyhydric carboxylic acid and a compound having a hydroxyl group or ethylene unsaturated bond, such as phthalic acid diester of β-hydroxyethyl(metha)acrylate, or toluene diisocyanate adduct of β-hydroxyethyl(metha)acrylate, or an adduct of polyisocyanate and a compound having a hydroxyl group or ethylene unsaturated bond, or toluene diisocyanate adduct of β-hydroxyethyl(metha)acrylate; and (metha)acrylic acid alkyl ester such as methyl(metha)acrylate, ethyl(metha)acrylate, butyl(metha)acrylate, or 2-ethylhexyl(metha)acrylate; 9,9′-bis[4-(2-acryloyloxyethoxy)phenyl]fluorene; however, the polymerizable monomer is not limited thereto. Any material known in the art to which the invention pertains may be used as the polymerizable monomer. In some cases, a silica dispersing agent may be used in these compounds. For example, Nanocryl XP series (0596, 1045, 21/1364) and Nanopox XP series (0516, 0525), manufactured by Hanse Chemie, may be used.

The content of b) the polymerizable monomer may range from 1 wt % to 40 wt % with respect to the total weight of the inkjet composition for the transparent film. When the content of the polymerizable monomer is less than 1 wt %, the heat resistance and strength of the transparent film may be lowered by insufficient crosslinking. When the content of the polymerizable monomer is more than 40 wt %, unreacted monomer may be denaturized during a curing process or an additional thermal treatment and thus the transmittance of the transparent film may be lowered.

Since neither a pigment nor a coloring agent is included in the composition, a) the binder polymer and b) the polymerizable monomer occupy most of the solid content. Therefore, the contents of the binder polymer and the polymerizable monomer may be freely increased as compared to the existing color ink composition, and the content ratio of the two materials may be easily adjusted. Since the pigment or the coloring agent are materials having a relatively high viscosity, a color ink composition including the same has a disadvantage in that the solid content thereof cannot be increased to more than a certain level because of its viscosity limitation for stable jetting. In the case of the composition according to the embodiment of the present invention, however, the burden on viscosity is not heavy and thus an ink having a relatively high solid content may be prepared.

The solid contents of the binder polymer and the polymerizable monomer may range from 95 wt % to 99 wt % with respect to the total solid content of the inkjet composition for the transparent film. When the contents of the binder polymer and the polymerizable monomer are less than 95 wt %, the transmittance thereof may be lowered or a fume maybe generated in a curing process to cause contamination therein. When the contents of the binder polymer and the polymerizable monomer are more than 99 wt %, the coatability of an ink film and the attachment properties to a substrate thereof may be degraded.

The weight ratio of a) the binder polymer to b) the polymerizable monomer is freely adjusted because viscosity limitations for jetting stability are low as compared to the existing color ink composition. However, when the content of the polymerizable monomer is too high, yellowing is caused by a thermal denaturation in the transparent film during a curing process or an additional thermal treatment. When the content of the polymerizable monomer is too low, the ink may not be well cured. Also, the total solid content of the inkjet composition is reduced, and thus, the number of ink drops necessary for forming an ink film having a specific thickness is increased, lowering the efficiency of an inkjet process.

Therefore, considering excellent permeability and heat resistance, the weight ratio of the binder polymer to the polymerizable monomer may be 1:2 or less, and more preferably 1:0.5-1:2.

c) The polymerization initiator may be at least one selected from a thermal polymerization initiator and a photo-polymerization initiator.

The thermal polymerization initiator may be selected from the group consisting of 2,2′-azobisisobutyronitrile (AIBN), 2,2′-azobis-(2,4-dimethylvaleronitrile), 2,2′-azobis-(4-methoxy-2,4-dimethylvaleronitrile), 2-cyano-2-propylazoformamide, 1,1′-azobis(cyclohexane-1-carbonitrile), 2,2′-azobis(2-methylbutyronitrile), V-40, VA-086,VA-085,VF096,VAm-110,Vam-111 (which are manufactured by Wako pure chemicals ind.), benzoyl peroxide, lauroyl peroxide, t-butylperoxypivalate, and 1,1′-bis-(bis-t-,butylperoxy)cyclohexane; however, the thermal polymerization initiator is not limited thereto.

The photo-polymerization initiator may be selected from the group consisting of: a triazine compound, such as 2,4-trichloromethyl-(4′-methoxyphenyl)-6-triazine, 2,4-trichloromethyl-(4′-methoxystyryl)-6-triazine, 2,4-trichloromethyl-(fipronil)-6-triazine, 2,4-trichloromethyl-(3′,4′-dimethoxyphenyl)-6-triazine, and 3-{4-[2,4-bis(trichloromethyl)-s-triazine-6-yl]phenylthio}propionic acid; a biimidazole compound, such as 2,2′-bis(2-chlorophenyl)-4,4′,5,5′-tetraphenyl biimidazole, 2,2′-bis(2,3-dichlorophenyl)-4,4′, and 5,5′-tetraphenylbiimidazole; an acetophenone compound (Irgacure-369), such as 2-hydroxy-2-methyl-1-phenylpropane-1-one, 1-(4-isopropylphenyl)-2-hyroxy-2-methylpropane-1-one, 4-(2-hyroxyethoxy-phenyl(2-hyroxy) propyl ketone, 1-hydroxycyclohexyl phenyl ketone, 2,2-dimethoxy-2-phenyl acetophenone, 2-methyl-(4-methylthiophenyl)-2-morpholino-1-propane-1-one (Irgacure-907), and 2-benzyl-2-dimethylamino-1-(4-morpholinophenyl)-butane-1-one; O-acyloxime compound, such as Irgacure OXE 01 and Irgacure OXE 02 (Ciba Geigy); a benzophenone compound, such as 4,4′-bis(dimethylamino)benzophenone and 4,4′-bis(diethylamino)benzophenone; a thioxanthone-based compound such as 2,4-diethyl thioxanthone, 2-chloro thioxanthone, isopropyl thioxanthone, or diiospropyl thioxanthone; a phosphine oxide compound such as 2,4,6-trimethylbenzoyl diphenylphosphine oxide, bis(2,6-dimethoxybenzoyl)-2,4,4-trimethylpentyl phosphine oxide, bis(2,6-dichlorobenzoyl)propyl phosphine oxide; and a coumarin compound such as 3,3′-carbonylvinyl-7-(diethylamino)coumarin, 3-(2-benzothiazoly)-7-(diethylamino)coumarin, 3-benzoly-7-(diethylamino)coumain, 3-benzoly-7-methoxy-coumarin, 10,10′-carbonylbis[1,1,7,7-tetramethyl-2,3,6,7-tetrahydro-1H,5H,11H—Cl]-benzopyrano[6,7,8-ij]-quinolizine-11-one.

The content of c) the polymerization initiator may range from 0.1 wt % to 5 wt % with respect to the total weight of the inkjet composition for the transparent film. When the content of the polymerization initiator is less than 0.1 wt %, the curing participation rate of the polymerizable monomer is lowered and thus the film strength and heat resistance of the manufactured transparent film may be degraded. When the content of the polymerization initiator is more than 5 wt %, radicals which do not participate in curing increase the contamination and viscosity of the inkjet composition for the transparent film, thereby lowering the jetting properties thereof.

d) The solvent having the boiling point of 150° C. or more is a high-boiling-point solvent having low volatility. The solvent may have a boiling point ranging from 150° C. to 250° C. Specifically, the solvent having a boiling point of 150° C. or more may be one or more selected from the group consisting of ethylene glycol monobutyl ether acetate, diethylene glycol monobutyl ether acetate, diethylene glycol monoethyl ether acetate, dipropylene glycol methyl ether acetate, ethoxy ethyl acetate, and butoxy ethyl acetate; however, the solvent is not limited thereto.

The content of d) the solvent having a boiling point of 150° C. or more may range from 40 wt % to 90 wt % with respect to the total weight of the inkjet composition for the transparent film. When the content of the solvent having a boiling point of 150° C. or more is less than 40 wt %, the entire viscosity of the composition is too high, and thus, the jetting stability thereof may not be ensured. When the content of the solvent having a boiling point of 150° C. or more is more than 90 wt %, the solid content is too small and thus the ink film may not be sufficiently formed. Consequently, the efficiency of the inkjet process may be degraded.

The inkjet composition for the transparent film according to the embodiment of the present invention may further include a surfactant, an adhesion promoter, a curing accelerator, a thermal polymerization inhibitor, a dispersing agent, a plasticizer, a filler, a defoaming agent, a dispersion assistant agent, a coagulation inhibitor, and one or more additives selected therefrom.

The content of the additive may range from 0.01 wt % to 0.5 wt % with respect to the total weight of the inkjet composition for the transparent film. When the content of the additive is out of the above range, the defoaming properties of the inkjet composition may be increased or the viscosity of the ink may be affected. Therefore, the characteristic of the inkjet process may be adversely affected.

The viscosity of the inkjet composition for the transparent film according to the embodiment of the present invention may range from 8 cP to 16 cP, and preferably from 11 cP to 13 cP. When the viscosity of the inkjet composition for the transparent film is less than 8 cP or more than 16 cP, the jetting stability thereof may be degraded.

Since the inkjet composition for the transparent film according to the embodiment of the present invention does not include a pigment having a relatively high viscosity, the viscosity necessary to be used in the inkjet process may be easily adjusted. Thus, various kinds of a binder, a polymerizable monomer, or other additives may be used according to desired purposes, without limitation on the purposes for viscosity adjustment, and their contents may be adjusted more easily. Also, due to the excellent transparency of the inkjet composition according to the embodiment of the present invention, it is easily applied to purposes for transparency.

In addition, the transparent film formed using the inkjet composition according to the embodiment of the present invention is provided.

After curing, the optical transmittance of the transparent film at the wavelength of 380 nm to 780 nm may be more than 98%.

Furthermore, the present invention provides a method for manufacturing a transparent film, including forming a transparent film of the inkjet composition by using an inkjet process. The inkjet process is a method which jets the inkjet composition by using an ink nozzle in a contactless manner.

Also, the present invention provides an electronic device including the transparent film as an overcoat.

Moreover, the present invention provides a color filter including the transparent film as a white pattern.

The color filter may be manufactured by: forming and curing a black matrix pattern on a substrate by using a method known in the art to which the invention pertains, thereby forming a light blocking portion and a pixel portion, which are partitioned by the black matrix, on the substrate; filling the pixel portion, which is partitioned by the black matrix, with the inkjet composition by using an inkjet process; and curing the filled inkjet composition.

The substrate may be selected from a glass substrate, a plastic substrate, or a flexible substrate; however, the substrate is not limited thereto. Specifically, a transparent glass substrate having high heat resistance may be used as the substrate.

The inkjet process is a method which jets ball-shaped ink to the pixel portion, which is partitioned by the black matrix, by using the ink nozzle in a contactless manner.

When the thermal initiator is used, the filled inkjet composition may be pre-baked at a temperature of 50° C. to 120° C. and then post-baked at a temperature of 220° C. to 280° C. When a thermal curing temperature is lower than 220° C., the evaporation and thermal curing of the solvent is insufficient and thus the strength and chemical resistance of the film may be lowered. When the thermal curing temperature is higher than 280° C., the volume of the pixel portion is excessively contracted. Thus, a problem may occur in the attachment and precision of the substrate and the formed film may be damaged by heat.

Also, when a photo-initiator is used, the curing of the filled inkjet composition may be at an exposure dose of 40 mJ/cm² to 300 mJ/cm². When the exposure dose is less than 40 mJ/cm², the photo-curing is insufficient and thus the strength and chemical resistance of the film may be degraded. When the exposure dose is more than 300 mJ/cm², the performing of an exposure process is time-consuming. Hence, a tack time maybe problematic. The ink film formed after the exposure process may be additionally cured in an oven at a temperature of 180° C. to 230° C.

### MODE FOR INVENTION

Hereinafter, examples will be described for helping in an understanding of the invention. However, the following examples are merely for the easy understanding of the invention, and the invention is not limited thereto.

### EXAMPLE 1

The inkjet composition for the transparent film was prepared by mixing 9 g copolymer, which included benzylacrylate, methacrylate, and methacrylic acid at a mole ratio of 60:10:30, as a binder polymer, 18 g dipentaaerythritol hexaacrylate (DPHA) as a polymerizable monomer, 0.5 g V40 as a thermal initiator, and 73 g diethylene glycol monobutyl ether acetate as a solvent for 3 hours.

### EXAMPLE 2

The inkjet composition for the transparent film was prepared by mixing 10 g copolymer, which included benzylacrylate, methacrylate, and methacrylic acid at a mole ratio of 60:10:30, as a binder polymer, 16 g dipentaaerythritol hexaacrylate (DPHA) as a polymerizable monomer, 0.5 g V40 as a thermal initiator, and 75 g diethylene glycol monobutyl ether acetate as a solvent for 3 hours.

### EXAMPLE 3

The inkjet composition for the transparent film was prepared by mixing 11 g copolymer, which included benzylacrylate, methacrylate, and methacrylic acid at a mole ratio of 60:10:30, as a binder polymer, 14 g dipentaaerythritol hexaacrylate (DPHA) as a polymerizable monomer, 0.5 g V40 as a thermal initiator, and 74 g diethylene glycol monobutyl ether acetate as a solvent for 3 hours.

### EXAMPLE 4

The inkjet composition for the transparent film was prepared by mixing 14.7 g copolymer, which included benzylacrylate, methacrylate, and methacrylic acid at a mole ratio of 60:10:30, as a binder polymer, 10.3 g dipentaaerythritol hexaacrylate (DPHA) as a polymerizable monomer, 0.5 g V40 as a thermal initiator, and 74. 1 g diethylene glycol monobutyl ether acetate as a solvent for 3 hours.

### COMPARATIVE EXAMPLE 1

The inkjet composition for the transparent film was prepared in the same manner as example 3, except that the solvent was replaced with propylene glycol monomethyl ether acetate (boiling point: 146° C.)

### COMPARATIVE EXAMPLE 2

The inkjet composition for the transparent film was prepared by mixing 18 g copolymer, which included benzylacrylate, methacrylate, and methacrylic acid at a mole ratio of 60:10:30, as a binder polymer, 7.2 g dipentaaerythritol hexaacrylate (DPHA) as a polymerizable monomer, 0.5 g V40 as a thermal initiator, and 74 g diethylene glycol monobutyl ether acetate as a solvent for 3 hours.

### COMPARATIVE EXAMPLE 3

The inkjet composition for the transparent film was prepared by mixing 7.5 g copolymer, which included benzylacrylate, methacrylate, and methacrylic acid at a mole ratio of 60:10:30, as a binder polymer, 18 g dipentaaerythritol hexaacrylate (DPHA) as a polymerizable monomer, 0.5 g V40 as a thermal initiator, and 73.5 g diethylene glycol monobutyl ether acetate as a solvent for 3 hours.

TABLE 1

| | Example | Example | Example | Example | Comp. | Comp. | Comp. |
|---|---|---|---|---|---|---|---|
| | 1 | 2 | 3 | 4 | Example 1 | Example 2 | Example 3 |
| Ratio of a:b | 1:2 | 1:1.6 | 1:1.3 | 1:0.7 | 1:1.3 | 1:0.4 | 1:2.4 |
| Solid Content (%) | 27 | 26 | 25 | 25 | 25 | 25 | 26.5 |
| Viscosity (cP) | 12.2 | 12.5 | 12.9 | 15.8 | 5.3 | 19.6 | 12.4 |
| transmittance | >98% | >99% | >99% | >99% | >99% | >99% | >97% |
| Evaluation of | Excel- | Excel- | Excel- | Excel- | Excel- | Excel- | Good |
| transmittance | lent | lent | lent | lent | lent | lent | |
| Transmittance | >94% | >95% | >96% | >98% | >96% | >98% | >92% |
| after thermal | | | | | | | |
| treatment | | | | | | | |
| Evaluation of | Good | Excel- | Excel- | Excel- | Excel- | Excel- | Bad |
| heat resistance | | lent | lent | lent | lent | lent | |
| Evaluation of | Normal | Normal | Normal | Normal | Abnormal | Unstable | Normal |
| inkjet process | | | | | | | |

* a: binder polymer b: polymerizable monomer

### EXPERIMENTAL EXAMPLE

The following method was used to test the transmittance and the heat resistance of the prepared inkjet composition for transparent film and the inkjet process properties. The inkjet compositions prepared by examples 1 to 4 and comparative examples 1 to 3 were spin-coated on the glass substrate, pre-baked at a temperature of about 90° C. for 3 minutes, and then post-baked in an IR oven (260-270° C.) for about 2 minutes, thereby forming a film having a thickness of 2 μm.

### EXPERIMENTAL EXAMPLE 1

### Evaluation of Transmittance

The transmittance at a wavelength of 380-780 nm was evaluated using a UV absorber. It was determined that the transmittance of the cured transparent coating film is excellent when it is 98% or more in an entire visible ray range.

### EXPERIMENTAL EXAMPLE 2

### Evaluation of Heat Resistance

The thermal treatment was additionally performed on the manufactured film at a temperature of 250° C. for 40 minutes, and the transmittance thereof at a wavelength of 380-780 nm was evaluated using a UV absorber. It was determined that the heat resistance of the film is excellent when the transmittance of the additionally thermally treated transparent coating film is 94% or more.

### EXPERIMENTAL EXAMPLE 3

### Evaluation of Inkjet Process

By evaluating the inkjet process on the inkjet compositions prepared by examples 1 to 4 and comparative examples 1 to 3, it was confirmed whether satellite and nozzle surface wetting/drying problems were caused and the ink was normally jetted.

As can be seen from the evaluation results of Table 1, the films manufactured by the inkjet compositions according to examples 1 to 4 exhibited excellent transmittance of 98% or more after the curing. Also, the excellent heat resistance evaluation result was exhibited when the weight ratio of the polymerizable monomer to the polymer binder was 1:2.0 or less. When the weight ratio of the polymerizable monomer to the polymer binder was more than 1:2.0, a yellowing phenomenon occurred. That is, the transmittance at a short wavelength range (about 400 nm) was reduced.

In addition, the inkjet compositions for the transparent film according to examples 1 to 4 had low volatility in the inkjet process evaluation and appropriate viscosity. Thus, satellite and nozzle surface wetting/drying problems did not occur, and ink was normally jetted through the entire nozzles to exhibit excellent jetting properties.

However, in the case of the inkjet composition for the transparent film according to comparative example 1, since a solvent having a low boiling point was used, the volatility was high and the viscosity was low. Thus, satellite occurred and the nozzle surface was dried. It was observed that the inkjet properties were not normal. That is, as the viscosity of the ink was reduced (less than 8 cP), satellite problems occurred and ink jetting was unstable.

Also, in the case of the inkjet composition for the transparent film according to comparative example 2, since the weight ratio of the binder polymer to the polymerizable monomer was less than 1:0.5, the content of the binder polymer having high viscosity within the ink increased and thus the ink viscosity exceeded 16 cP. As a result, the jetting properties thereof were degraded and the surface uniformity of the transparent film was degraded. Much burden was imposed to the inkjet apparatus because a voltage necessary for normal ink jetting was increased. Therefore, the inkjet properties became unstable.

Also, in the case in which the weight ratio of the binder polymer to the polymerizable monomer was less than 1:0.5, such as in comparative example 2, if the viscosity of the ink was reduced to an appropriate level (8-16 cP) in order to improve the unstable inkjet properties, the efficiency of the inkjet process was lowered. Specifically, the solid content of the inkjet composition must be reduced to 20% or less in order to reduce the viscosity of the ink to an appropriate level (8-16 cP), while maintaining the weight ratio of the binder polymer to the polymerizable monomer to less than 1:0.5. However, if the solid content of the inkjet composition is reduced, the number of ink drops to be jetted for forming an ink film having a specific thickness is increased. Thus, the efficiency of the inkjet process is degraded.

Also, like in comparative example 3, the film manufactured using the inkjet composition including more than two times the polymerizable monomer with respect to the content of the binder polymer is vulnerable to the heat resistance.

1. An inkjet composition for a transparent film, comprising:
a) a binder polymer;
b) a polymerizable monomer;
c) a polymerization initiator; and
d) a solvent having a boiling point of 150° C. or more.

2. The inkjet composition of claim 1, wherein the inkjet composition has a three-dimensional mesh structure.

3. The inkjet composition of claim 1, wherein the content of a) the binder polymer ranges from 1 wt % to 40 wt % with respect to the total weight of the inkjet composition, the content of b) the polymerizable monomer ranges from lwt % to 40 wt % with respect to the total weight of the inkjet composition, the content of c) the polymerization initiator ranges from 0.lwt % to 5 wt % with respect to the total weight of the inkjet composition, and the content of d) the solvent having the boiling point of 150° C. or more ranges from 40 wt % to 90 wt % with respect to the total weight of the inkjet composition.

4. The inkjet composition of claim 1, wherein the weight average molecular weight of a) the binder polymer ranges from 1,000 to 100,000.

5. The inkjet composition of claim 1, wherein the weight ratio of a) the binder polymer to the polymerizable monomer ranges from 1:0.5 to 1:2.

6. The inkjet composition of claim 1, wherein the viscosity of the inkjet composition ranges from 8 cP to 16 cP.

7. The inkjet composition of claim 1, wherein the binder polymer comprises acrylate monomer, acrylate oligomer, or a mixture thereof.

8. The inkjet composition of claim 1, wherein the solid contents of a) the binder polymer and b) the polymerizable monomer range from 95 wt % to 99 wt % with respect to the total solid content of the inkjet composition.

9. The inkjet composition of claim 1, wherein d) the solvent having the boiling point of 150° C. or more comprises one or more selected from the group consisting of ethylene glycol monobutyl ether acetate, diethylene glycol monobutyl ether acetate, diethylene glycol monoethyl ether acetate, dipropylene glycol methyl ether acetate, ethoxy ethyl acetate, and butoxy ethyl acetate.

10. The inkjet composition of claim 1, further comprising a surfactant, an adhesion promoter, a curing accelerator, a thermal polymerization inhibitor, a dispersing agent, a plasticizer, a filler, a defoaming agent, a dispersion assistant agent, a coagulation inhibitor, and one or more additives selected therefrom, wherein the content of the additive ranges from 0.1 wt % to 0.5 wt % with respect to the total weight of the inkjet composition.

11. A transparent film manufactured by the inkjet composition of claim 1.

12. The transparent film of claim 11, wherein the optical transmittance of the transparent film at a wavelength of 380 nm to 780 nm is more than 98% after curing.

13. A method for manufacturing a transparent film, comprising forming a transparent film using the inkjet composition of claim 1 through an inkjet process.

14. An electronic device comprising the transparent film of claim 11 as an overcoat.

15. A color filter comprising the transparent film of claim 11 as a white pattern.
